(19) United States
(12) Patent Application Publication
(10) Pub. No.: US 2007/0204423 A1
(43) Pub. Date: Sep. 6, 2007

(54) Painting Tray

(76) Inventor: Carolyn Keane, Lake Worth, FL (US)

Correspondence Address: AKERMAN SENTERFITT, P.O. BOX 3188, WEST PALM BEACH, FL, 33402-3188, US

(21) Appl. No.: 11/745,404

(22) Filed: May 7, 2007

Related U.S. Application Data
(63) Continuation-in-part of application No. 11/057,483, filed on Feb. 14, 2005.
(60) Provisional application No. 60/559,848, filed on Apr. 6, 2004.

(51) Int. Cl. B05C 21/00

(52) U.S. Cl. 15/257.06; 15/257.05; 220/570

(57) ABSTRACT

A paint tray that includes an end wall at a first end and an open reservoir at a second end opposite the first end. The open reservoir has a drain plug and includes a front wall, a back wall, an angled base, and two side walls extending longitudinally from the angled base to the end wall. An inclined rolling panel extend between the end wall and the back wall of the open reservoir. A stabilizing structure extends from a back surface of the inclined rolling panel and the angled base includes at least one foot. The end wall includes a carrying handle, an integrated roller frame holder and at least one hooked structure for supporting a painting tool. The paint tray can hang from a ladder rung in a relatively vertical position or can be mounted to a ladder step in a horizontal orientation.

### CROSS REFERENCE TO RELATED APPLICATION

This application is a continuation-in-part claiming priority to currently pending U.S. patent application Ser. No. 11/057,483 filed on Feb. 14, 2005, with the title PAINTING ACCESSORY, and abandoned U.S. Provisional Patent Application Ser. No. 60/559,848 filed on Apr. 6, 2004, with the title PAINTING ACCESSORY, the entirety of which are hereby incorporated by reference.

### FIELD OF THE INVENTION

The present application relates to paint trays, more particularly, paint trays designed to transport painting tools, such as brushes and rollers.

### BACKGROUND OF THE INVENTION

Paint trays and rollers have been available for many years. Until relatively recently, paint trays for rollers have been open four-sided receptacles usually of metallic material which could be attached to ladder rungs by hook-like extensions and which were typically horizontally oriented.

Recently, a modified design has been developed to enable the tray to assume a variety of different orientations. The flat tray-like device has a receptacle area of generally L-shaped configuration. The tray may have a handle at the opposite end from the L-shaped receptacle area so that the device may be set upright with its longest dimension oriented generally vertically. This modified style paint tray device can also be oriented horizontally so that the ripple portion is horizontal, as previous trays were typically oriented.

This style tray can be easily carried as the L-shaped portion has a side and two ends that form a reservoir deep enough to accommodate a considerable volume of paint while being carried by a unitary handle. This new design greatly increases the portability of paint trays and makes it possible to switch between horizontal and vertical orientations.

While this improved tray design has advantages over the earlier designs that could be used in only one orientation, i.e. with the ripple structure horizontal, there are still a variety of shortcomings of the improved devices.

One shortcoming is that it is still difficult to hold a paint roller while using a paint brush or to carry the paint tray up a ladder with a paint brush, a roller or both.

Painting jobs typically require intermittent but regular use of brushes and other painting tools. Thus, it is a disadvantage that the improved devices cannot accommodate paint brushes when not in use. This problem is particularly acute when the painter uses the paint tray on a ladder or any other location where storage space is limited. It is desirable to have a storage place for brushes when a roller is in use and vice versa for a roller when a brush is in use.

Although rollers have been around for many years, and are routinely used in conjunction with brushes, there is no readily available structure where both a brush and a roller can be attached to a paint tray when not in use in such a way that any drippings from the brush will be into the open reservoir or tray and not over surrounding locations.

Although trays have accommodated rollers of ordinary size, there has been no tray particularly adaptable for use with trim painting.

### SUMMARY OF THE INVENTION

The present invention is directed to a paint tray that can include an end wall at a first end and an open reservoir at a second end opposite the first end. The open reservoir can include a front wall, a back wall, an angled base and two side walls extending longitudinally from the angled base to the end wall. An inclined rolling panel can extend between the end wall and the back wall of the open reservoir and a stabilizing structure can extend from a back surface of the inclined rolling panel. The paint tray can also include a drain plug in fluid communication with the open reservoir and at least one foot can protrude from the angled base. The end wall can include a carrying handle, an integrated roller frame holder and at least one hooked structure for supporting a painting tool.

The at least one hooked structure can be designed to secure a painting tool by a hole in a handle of the painting tool. The open reservoir can extend forward a sufficient distance relative to the end wall that paint dripping from a paint brush secured by the at least one hooked structure can drip into the open reservoir when the paint tray is oriented in a generally vertical orientation. The open reservoir can extend forward a sufficient distance relative to the end wall that paint dripping from a roller attached to a roller frame secured by the integrated roller frame holder will drip into the open reservoir when the paint tray is oriented in a generally vertical orientation.

The integrated roller frame holder can include a notch in the end wall for receiving a shaft of a roller frame. The integrated roller frame holder can also include an arch-shaped lip surrounding at least a portion of the notch. The arch-shaped lip can be generally circular. The integrated roller frame holder can also include a generally circular recess, which can form a cylindrical housing, surrounding at least a portion of the notch.

The open reservoir can include a trough formed by the angled base. The drain plug can be in line with the trough. The interior angle formed at the intersection of the angled base and the back wall can be an obtuse angle and the interior angle formed at the intersection of the angled base and the front wall can be an obtuse angle.

The trough can also be formed by the intersection of the angled base and the back wall. In this embodiment, the interior angle formed at the intersection of the angled base and the back panel can be an acute angle.

The stabilizing structure can include at least one V-shaped leg, where each V-shaped leg includes a first member and a second hooking member and the angle between the first member and the second hooking member is 95° or less. The stabilizing structure can include at least one V-shaped leg, each V-shaped leg comprising a first member and a second hooking member, where the second hooking member provides a weight in order to counter-balance changes in the weight distribution caused by paint and hanging paint applicators.

The carrying handle can be located forward of or directly above the center of gravity of the paint tray when the paint tray is in a vertical orientation and the open reservoir is at most half full.

An advantage of the present invention is providing a paint tray to which a roller, a painting tool, or both can be attached when not in use.

Another advantage of the present invention is that the inventive paint tray can be attached to a ladder step and used in a cantilevered configuration.

Yet another advantage of the invention is that the inventive paint tray provides a drain plug for emptying the open reservoir into a storage container. Yet another advantage of the present invention is that the inventive paint tray includes a trough to assist drainage of the open reservoir.

Another advantage of the present invention is that the inventive paint tray includes a trough which forces fluid in the open reservoir to pool into a small area resulting in improved efficiency saturating the painting tool and less wasted fluid during painting.

Yet another advantage of the present invention is that the inventive paint tray provides a rotational bias that reduces the likelihood of spilling fluid in the open reservoir during transport of the paint tray. Another advantage of the present invention is that the inventive paint tray provides a rotational bias that allows the paint tray to be suspended from a single ladder rung without being supported by a second ladder rung.

### BRIEF DESCRIPTION OF THE DRAWINGS

The objects, features and advantages of the present invention will be more clearly understood from the following detailed description in conjunction with the accompanying drawings, in which:

FIG. 1 is a perspective view of the paint tray assuming a vertical orientation;

FIG. 2 is a front elevation view of the paint tray;

FIG. 3 is a rear elevation view of the paint tray;

FIG. 4 is a left side elevation view of the paint tray;

FIG. 5 is a right side elevation view of the paint tray;

FIG. 6 is a top view of the paint tray;

FIG. 7 is a bottom view of the paint tray;

FIG. 8 is a front elevation view of a paint tray having a deep trough;

FIG. 9 is a cross-sectional view of the paint tray of FIG. 8 taken along line 9-9, where the paint tray is in a vertical orientation;

FIG. 10 is a cross-sectional view of the paint tray of FIG. 8 taken along line 9-9, where the paint tray is in a horizontal orientation;

FIG. 11 is a front elevation view of an paint tray having a single panel angled base;

FIG. 12 is a cross-sectional view of the paint tray of FIG. 11 taken along line 12-12, where the paint tray is in a horizontal orientation;

FIG. 13 is a side elevation view of the paint tray hanging from a ladder rung;

FIG. 14 is a side elevation view of the paint tray attached to a ladder step in a cantilevered orientation;

FIG. 15 is a side elevation view of the paint tray showing several painting tools attached to the integrated roller frame holder and the hooked structures; and

FIG. 16 is a perspective view of the paint tray showing several painting tools attached to the integrated roller frame holder and the hooked structures.

### DETAILED DESCRIPTION

Embodiments in accordance with the present invention demonstrate a painting tray that directly addresses the deficiencies of the prior art. The painting tray provides one or more hooked structures for supporting a plurality of painting tools and other suitable devices. Further, the painting tray includes an in integrated roller frame holder that can support a roller when not in use, such as when moving up and down a ladder. The integrated roller frame holder can be recessed such that the supported roller hangs close to or in line with the a center of gravity of the painting tray to prevent the painting tray from toppling when in an upright orientation. Further, supporting the roller frame holder at a recessed position can prevent paint from inadvertently dripping outside of the painting tray. Still further, the painting tray is dimensioned to allow for use in multiple orientations, such as standing upright, laying on a flat surface, hooked onto ladder rungs and even secured safely to the top of a ladder.

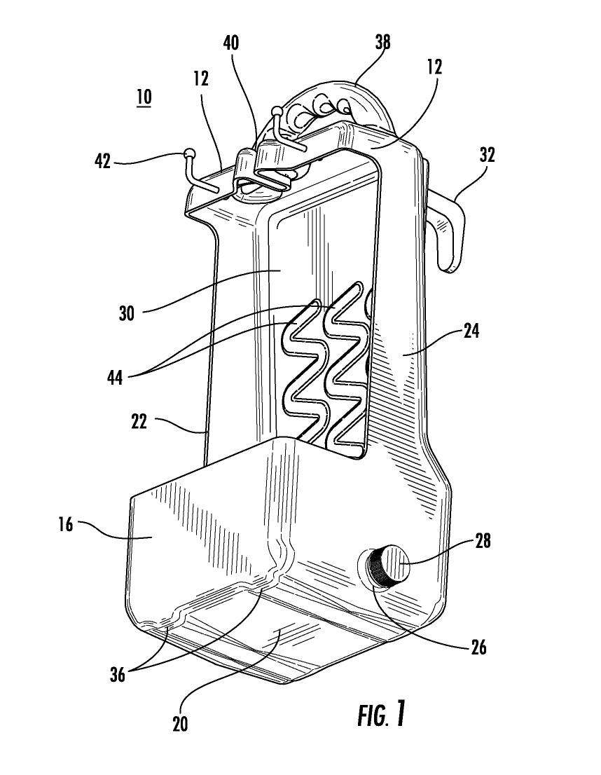

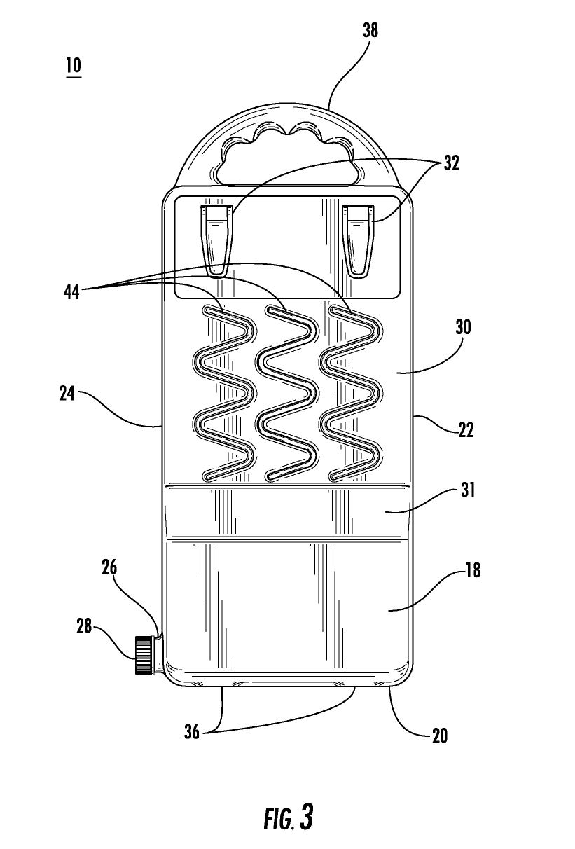

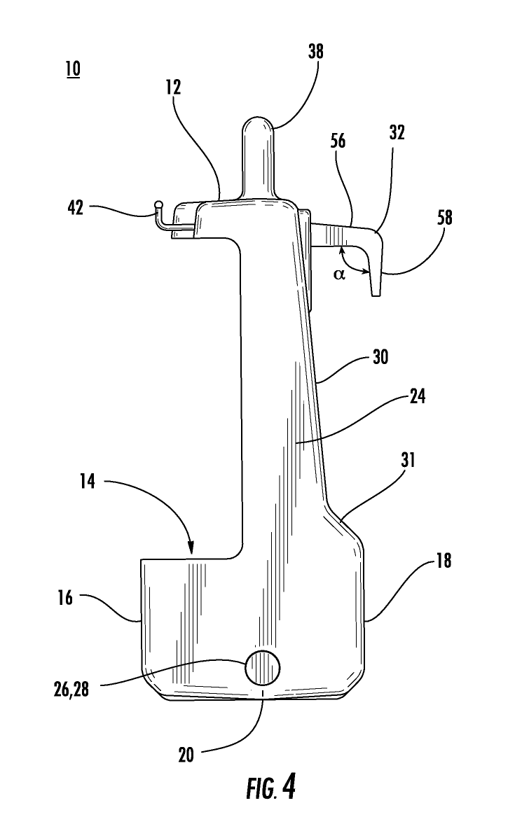

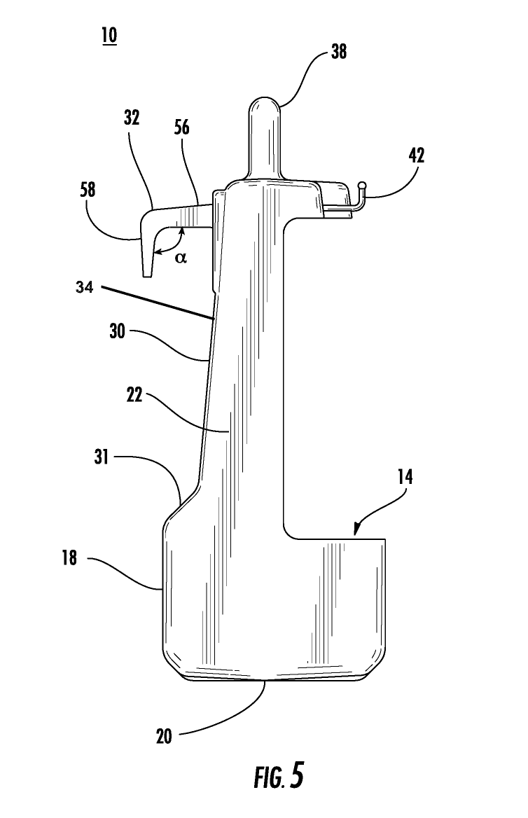

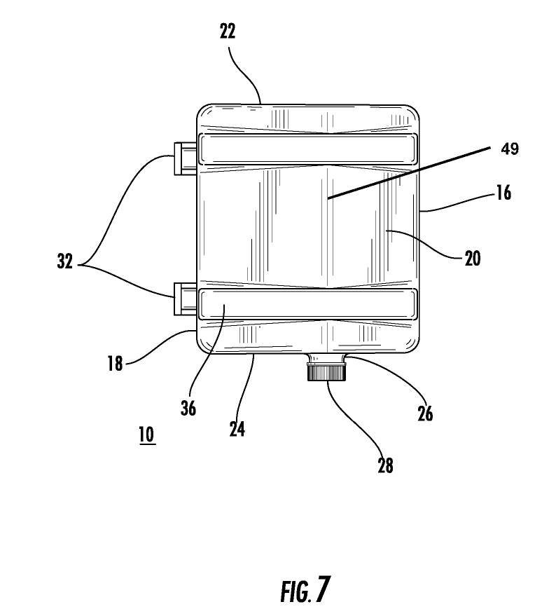

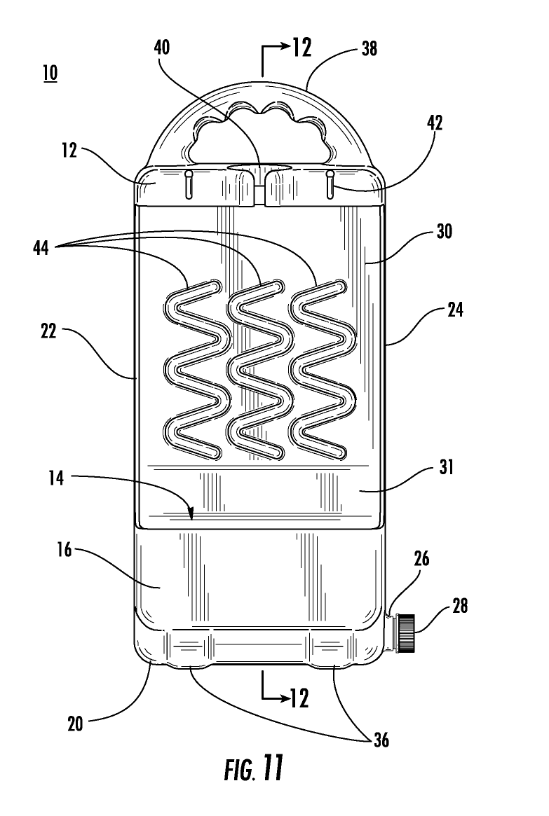

FIGS. 1-16 show a paint tray 10 that includes an end wall 12 at a first end and an open reservoir 14 at a second end opposite the first end. In a generally vertical origination, the first can be considered a top and the second end can be considered a bottom end. The open reservoir 14 can be formed by a front wall 16, a back wall 18, an angled base 20, and two side walls 22 & 24 extending longitudinally from the angled base 20 to the end wall 12. A drain plug 26 with a drain cap 28 is located in fluid communication with the open reservoir 14. An inclined rolling panel 30 extends longitudinally from the end wall 12 toward the back wall 18 of the open reservoir 14. The inclined rolling panel 30 can intersect the back wall 18 directly, or an intermediate panel 31 can extend between the inclined rolling panel 30 and the back wall 18. Where an intermediate panel 31 is present, the intermediate panel can be inclined at an angle between that of the inclined rolling panel 30 and the back wall 18. A stabilizing structure 32 extends from the back surface 34 of the inclined rolling panel 30 and one or more feet 36 protrude from the angled base 20.

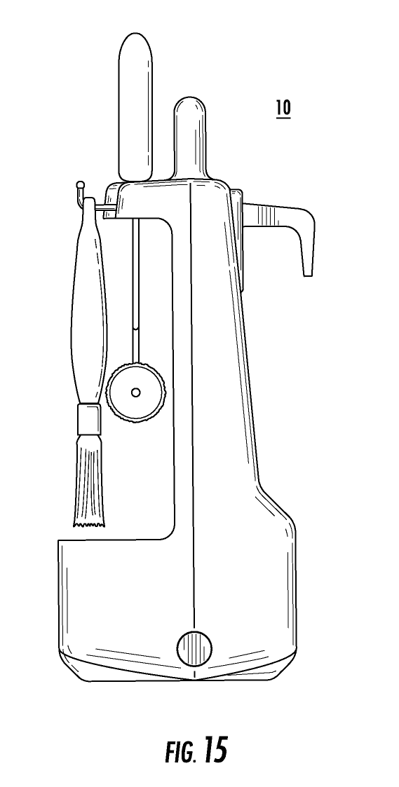

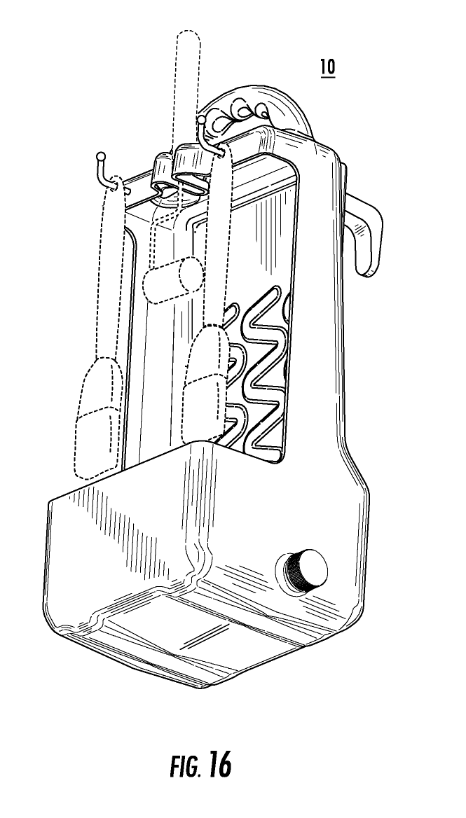

The end wall 12 can also include a carrying handle 38, an integrated roller frame holder 40 and at least one hooked structure 42 for supporting a painting tool. As used herein, the term “painting tool” includes tools used during the painting process including, but not limited to, paint brushes, foam paint brushes, roller frames, squeegees, putty knives, scrapping knives, and razor knives. As shown in FIGS. 15 and 16, the hooked structure 42 can be designed to secure a painting tool by a hole in a handle of the painting tool. Although not shown, the hooked structure 42 could be used to secure a painting tool by a loop attached to a painting tool or any other known method for securing an item to a hooked structure.

The inclined rolling panel 30 has ripples 44 that can force excess paint from a roller (not shown) as the roller is rolled over the ripples 44. The paint tray 10 can be designed for detailed painting, such as trim work, touch-up, etc., either alone or part of a larger paint project. Because trim work often requires the painter to stand on a ladder that must be moved regularly, prior to the invention, it was cumbersome to use a paint tray 10 when working on a ladder to paint trim and perform touch-up work.

Trim work generally requires one or more paint brushes and one or more rollers. Thus, it was difficult to safely climb a ladder while simultaneously carrying paint brushes, rollers and the paint tray. However, the paint tray 10, with a roller and brushes secured thereto, can be safely carried up and down a ladder and conveniently carried from location to location on a site. The ability to carry each of these different painting tools is extremely useful for painting from a ladder and especially for detail work, such as trim.

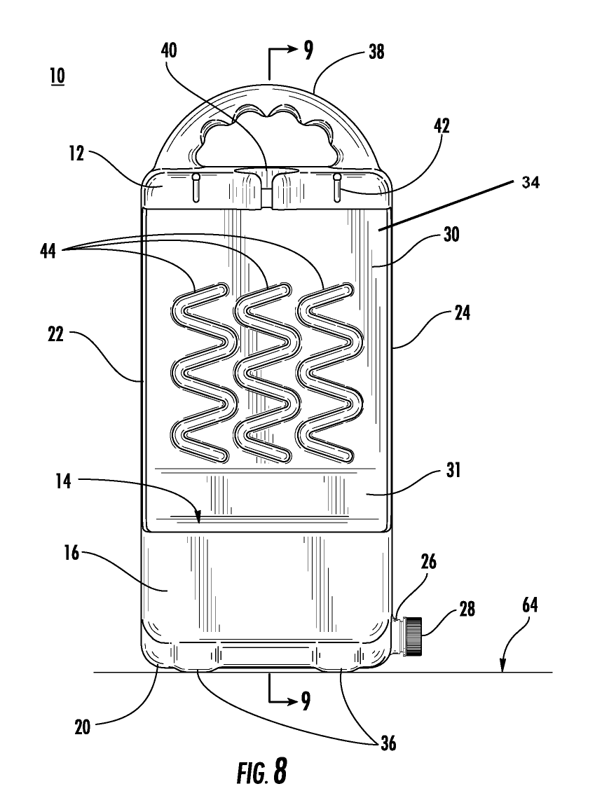

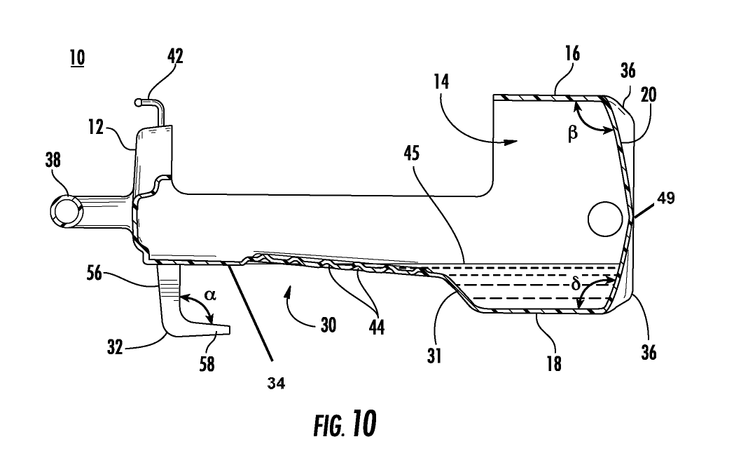

When the paint tray 10 is in a vertical orientation, as in FIGS. 8 & 9, paint can collect within the open reservoir 14. Paint line 45 represents paint disposed within the paint tray 10. Of course, if the paint tray 10 is rotated 90 degrees, as shown in FIG. 10, the back wall and the inclined roller panel 30 can function as a base to retain the paint within the paint tray 10.

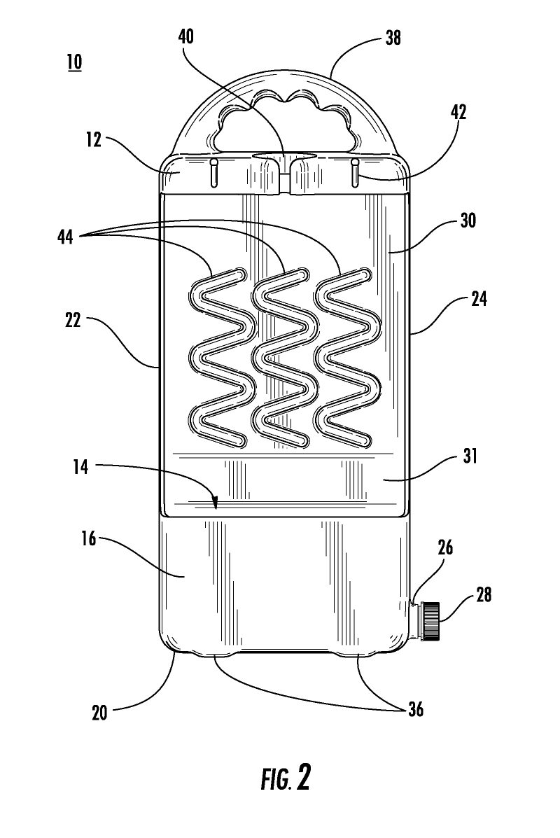

As best shown in FIGS. 2 & 6, an integrated roller frame holder 40 can be incorporated into the end wall 12. The integrated roller frame holder 40 can include a notch 46 in the end wall 12 for receiving a shaft of a roller frame holder. Each integrated roller frame holder 40 can include an arch-shaped lip 48 surrounding at least a portion of the notch 46. In an alternative embodiment, the integrated roller frame holder 40 can include an arch shaped lip 48 and generally circular recess 51 forming a generally cylindrical housing surrounding at least a portion of the notch 46. As used herein, “generally circular” is used to describe any variant of a round shape including, but not limited to, circles, ovals and ellipses, and portions of various rounds shapes, including but not limited to semicircles. The arch-shaped lip 48 and circular recess 51, which can form a cylindrical housing, surrounding the notch 46 can prevent a roller frame secured in the integrated roller frame holder 40 from being jarred loose from the roller frame holder 40. Also, the cylindrical housing can accept a roller frame handle, such as a larger cylindrical wooden handle. This reduces the likelihood that a roller frame will fall out of the roller frame holder 40 and inadvertently transfer wet paint to carpets, furniture or other materials typically found on a job site. Additionally, the arched shaped lip 48 with rounded protrusions extending from the end wall 12 are in contrast to the generally rectangular shape of the end wall 12. Such rounded protrusions enable a user to insert roller frame by touch without requiring the user to turn or adjust their body to visually inspect the integrated roller frame holder 40 and carefully insert a roller frame. Such ease of use can allow the user to maintain their balance while standing on a ladder or another support structure.

The open reservoir 12 can include a trough 49. The trough 49 can be formed by the angled base 20. The trough 49 can be used to maximize the amount of fluid that may be drained from the paint tray 10 into another container via gravity, thereby, reducing the amount of cleaning necessary and minimizing the amount of wasted paint. Because paint will accumulate in the trough 49, the trough 49 feature can be particularly useful in applications, such as touch-up and trim, where only minimal amounts of paint need to be applied.

The drain plug 26 can be in line with the trough 49. This maximizes the amount of fluid that may be drained from the paint tray 10 without direct intervention of the user. The drain plug 26 can be covered with a drain cap 28. Both the drain cap 28 and the drain plug 26 can be threaded for easy application and removal of the drain cap 28. Although threads are described, alternative methods of attaching caps may also be used, for example a snapping mechanism.

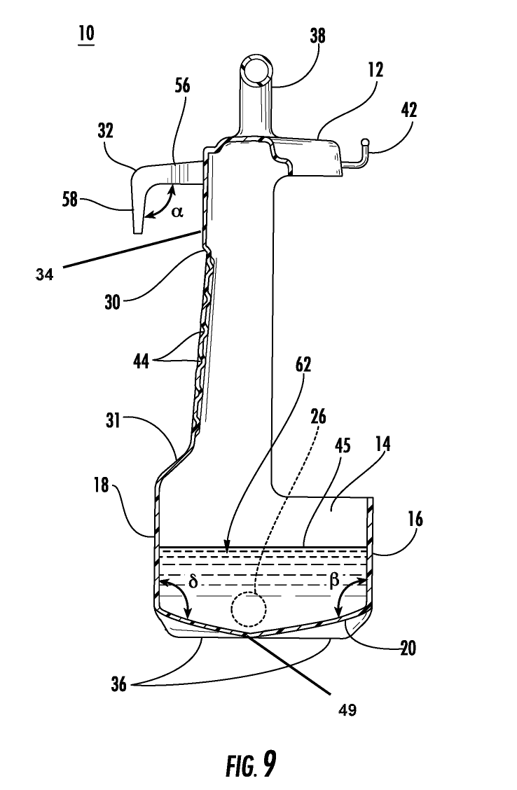

As shown in FIG. 9, the trough 49 can be formed by the angled base 20. In this embodiment, the interior angle delta (δ) formed at the intersection of the angled base 20 and the back wall 18 can be an obtuse angle, and the interior angle beta (β) formed at the intersection of the angled base 20 and the front wall 16 can be an obtuse angle.

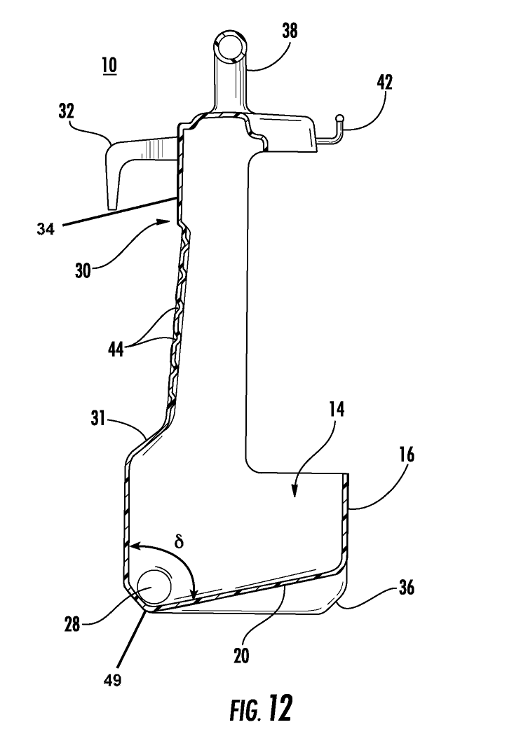

As shown in FIG. 12, the trough 49 can be formed at the intersection of the angled base 20 and the back wall 16. In this embodiment, the interior angle delta (δ) formed at the intersection of the angled base 20 and the back wall 16 can be an acute angle.

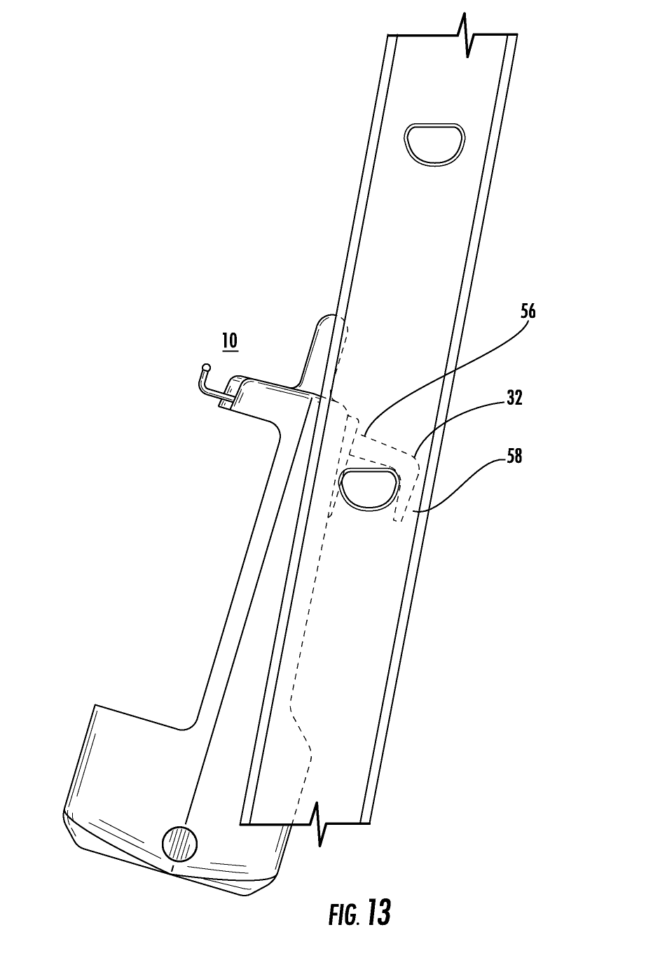

The stabilizing structure 32 can be integral with and extending from rolling panel 30. The stabilizing structure 32 can include one or more V-shaped legs 32, each V-shaped leg 32 having a first member 56 and a second hooking member 58. The hooking member angle alpha (α), i.e. angle (α) between the first member 56 and the second hooking member 58, can be 95° or less. The hooking member angle (α) can be 90° or less, 80° or less, 60° or less, or even 45° or less. The small hooking member angle (α) is useful for rung mounting and cantilevered mounting as shown in FIGS. 13 & 14, respectively. With respect to rung mounting, the small hooking member angle alpha (α) enables secure attachment of the paint tray 10 to a ladder rung without requiring that the lower portion of the paint tray 10 rest on a second ladder rung. With respect to cantilevered mounting, the small hooking angle alpha (α) provides improved stability by increasing the friction between the ladder step and the hooking member 58.

As shown in FIG. 9, the carrying handle 38 can be located so that it is forward of or directly above the center of gravity 62 of the paint tray 10 when the paint tray 10 is in a vertical orientation and the open reservoir 14 is at most half full. As shown in FIG. 9, this configuration causes the open reservoir 14 to rotate slightly counter-clock-wise when the paint tray 10 is held by the carrying handle 38. This novel handle 38 placement reduces the likelihood that paint will spill from the open reservoir 14 while the tray 10 is being transported. In a preferred embodiment, the carrying handle 38 can be located so that it is forward of or directly above the center of gravity 62 of the paint tray 10 when the paint tray 10 is in a vertical orientation and the open reservoir is at most two-thirds full, more preferably at most three-quarters full, and most preferably completely full.

The second hooking member 58 can serve as a counter-balance designed to offset changes in the weight distribution caused by paint and hanging paint applicators. In one embodiment, the counter-balance design can be achieved by the weight provided by the second hooking member 58. This design feature may be used to offset any rotational forces created by the hanging of paint tool that is loaded with paint. Similarly, the rear wall 18 may be shifted to make the open reservoir 14 deeper or shallower to adjust the center of gravity 62 and increase the overall stability.

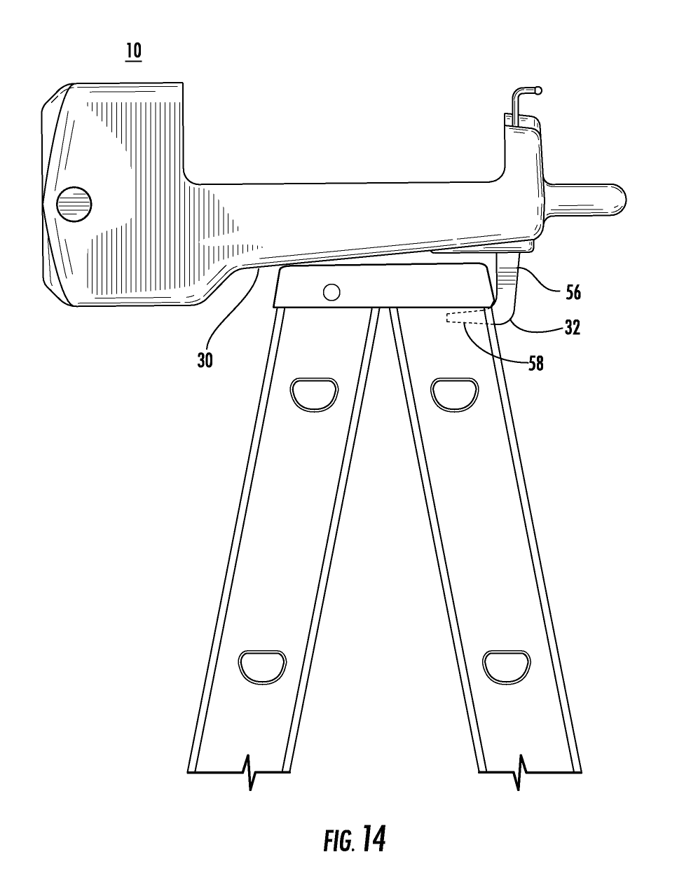

As shown in FIG. 14, the paint tray 10 can be attached to a ladder step in a cantilevered orientation. When the paint tray 10 hangs by the stabilizing structures 32 as shown in FIG. 13, the forces exerted at the mounting point are primarily rotational. In contrast, when the paint tray 10 is mounted in a cantilevered orientation the forces exerted at the mounting point are substantially perpendicular to the back surface 29 of the inclined rolling panel 30. In cantilevered attachment, as shown in FIG. 14, the integral stabilizing structures 32 sufficiently support the painting tray 10 without the possibility of being dislodged as exists with non-integral or structures that are merely slidably connected.

As shown in FIG. 15, the open reservoir 14 may extend forward a sufficient distance relative to the end wall 12 that paint dripping from a paint brush, or a similarly sized painting tool, secured by one of the hooked structures 42 will drip into the open reservoir 14 when the paint tray 10 is oriented in a generally vertical orientation. Similarly, the open reservoir 14 can extend forward a sufficient distance relative to the end wall 12 that paint dripping from a roller attached to a roller frame secured by the integrated roller frame holder 40 will drip into the open reservoir 14 when the paint tray 10 is oriented in a generally vertical orientation. Finally, the open reservoir 14 can extend forward and laterally a sufficient distance relative to the placement of a hooked structure 42 extending from the end wall 12, the integrated roller frame holder 40 or both, that no paint dripping from either paint applicator drips outside the open reservoir 14 when the paint tray 10 is oriented in a generally vertical orientation. This feature may be provided by an embodiment where the front wall 16 of the open reservoir 14 extends further forward than the forward-most portion of the end wall 12. This feature is of particular interest when the tray 10 is being transported by the carrying handle 38 or where the tray 10 is hanging from an upper ladder rung without resting on a lower ladder rung.

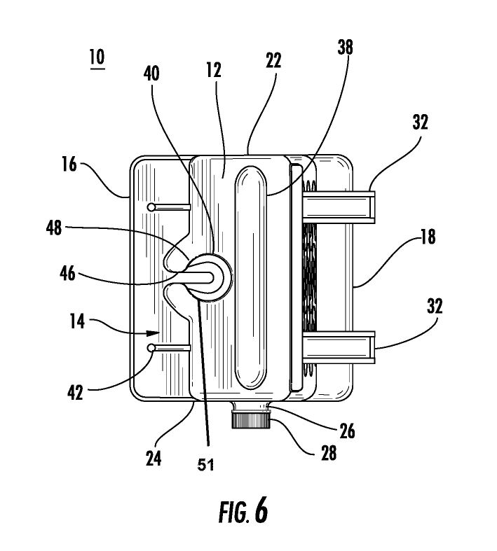

Further, as shown in FIG. 6, the notch 46 can extend from a periphery of the end wall 12 towards the inclined rolling panel 30 to be sufficiently removed from the periphery of the end wall 12. Such an arrangement will result in the roller frame hanging immediately adjacent to the rolling panel 30 and generally in line with the vertical center of masses of the paint tray 10. Accordingly, the extension of the notch 46 towards the rolling panel 30 results in roller frame being supported recessed from the periphery of the end wall where the roller frame does not extend beyond the periphery of the end wall and does not create any substantial tipping force even when the roller is saturated with paint.

As used herein, the paint tray 10 is in a “vertical orientation” when the feet 36 of the tray 10 support the tray 10 on a horizontal surface 64, as shown in FIG. 8. As used herein, the paint tray 10 is in a “generally vertical orientation” when the paint tray 10 is within 10 degrees of a vertical orientation.

The paint tray 10 may be sized to accommodate a roller for trim painting or a full size roller. The paint tray 10 may be particularly useful for detailed work, such as trim work, where multiple painting tools are used by a painter standing on a ladder. Although the invention is described as a paint tray 10, the portable tray 10 can be used in any application where a worker needs to stand on a ladder to apply a fluid or paste using tools. For example, the open reservoir 14 can contain wallpaper paste and the hooked structures 42 used to secure a paste brush and squeegee. In another use, the open reservoir 14 can contain joint compound or spackle and the hooked structures 42 used to secure putty knives and joint tape.

The paint tray 10 may be made using any suitable material, for example metal or plastic. Similarly, any process capable of producing the paint tray 10 may be used. In one embodiment, the paint tray 10 may be produced with a thermoplastic resin using injection molding or blow molding.

This invention can be embodied in other forms without departing from the spirit or essential attributes thereof. Although suitable methods and materials have been described above, methods and materials similar or equivalent to those described herein can be used in the practice or testing of the present invention. All publications, patent applications, patents, and other references mentioned herein are incorporated by reference in their entirety. In the case of conflict, the present specification, including definitions will control. Reference should be made to the following claims, rather than to the foregoing specification, as indicating the scope of the invention.

What is claimed is:

1. A paint tray, comprising:
an end wall at a first end;
an open reservoir at a second end opposite the first end, the open reservoir including a front wall, a back wall, an angled base, and two side walls extending longitudinally from the angled base to the end wall;
an inclined rolling panel extending between the end wall and the back wall of the open reservoir;
a stabilizing structure extending from a back surface of the inclined rolling panel; and
a drain plug in fluid communication with the open reservoir,
wherein the end wall includes an integrated roller frame holder and at least one hooked structure for supporting a painting tool.

2. The paint tray of claim 1, wherein the at least one hooked structure is designed to secure a painting tool by a hole in a handle of the painting tool.

3. The paint tray of claim 1, wherein the open reservoir extends forward a sufficient distance relative to the end wall that paint dripping from a paint brush secured by the at least one hooked structure will drip into the open reservoir when the paint tray is oriented in a generally vertical orientation.

4. The paint tray of claim 1, wherein the open reservoir extends forward a sufficient distance relative to the end wall that paint dripping from a roller attached to a roller frame secured by the integrated roller frame holder will drip into the open reservoir when the paint tray is oriented in a generally vertical orientation.

5. The paint tray of claim 1, wherein the integrated roller frame holder comprises a notch in the end wall for receiving a shaft of a roller frame.

6. The paint tray of claim 5, wherein the integrated roller frame holder further comprises an arch-shaped lip surrounding at least a portion of the notch.

7. The paint tray of claim 6, wherein the arch-shaped lip is generally circular.

8. The paint tray of claim 5, wherein the arch-shaped lip includes a generally circular recess surrounding at least a portion of the notch.

9. The paint tray of claim, wherein the notch extends from a periphery of the end wall towards the inclined rolling panel such that a supported roller frame does not extend beyond the periphery of the end wall.

10. The paint tray of claim 1, further comprises a trough formed by the angled base.

11. The paint tray of claim 10, wherein the drain plug is in line with the trough.

12. The paint tray of claim 10, wherein an interior angle formed at an intersection of the angled base and the back wall is an obtuse angle and an interior angle formed at an intersection of the angled base and the front wall is an obtuse angle.

13. The paint tray of claim 10, wherein the trough is formed at an intersection of the angled base and the back wall, wherein an interior angle formed at an intersection of the angled base and the back panel is an acute angle.

14. The paint tray of claim 1, wherein the stabilizing structure comprises at least one V-shaped leg, each V-shaped leg having a first member and a second hooking member, wherein the angle between the first member and the second hooking member is 95° or less.

15. The paint tray of claim 1, wherein the stabilizing structure includes at least one V-shaped leg, each V-shaped leg having a first member and a second hooking member, wherein the second hooking member provides a weight in order to counter-balance changes in the weight distribution caused hanging paint tools.

16. The paint tray of claim 1, wherein the carrying handle is forward of or directly above the center of gravity of the paint tray when the paint tray is in a vertical orientation.

17. The paint tray of claim 1, wherein at least one foot protrudes from the angled base.

18. The paint tray of claim 1, further comprising a carrying handle attached to the end wall.
